(19) United States
(12) Patent Application Publication
(10) Pub. No.: US 2011/0085234 A1
(43) Pub. Date: Apr. 14, 2011

(54) Microscope stand

(76) Inventor: Dieter Feger, Wien (AT)

(21) Appl. No.: 12/588,285

(22) Filed: Oct. 9, 2009

(51) Int. Cl. G02B 21/06; G02B 21/00; G02B 7/00; G02B 21/36

(52) U.S. Cl. 359/363; 359/368; 359/390

(57) ABSTRACT

A microscope stand for holding an optical and/or opto-electronical (e.g. video) observation system is mechanically connected to a microscope base, such as a basis plate, feet or rack or the like. In at least one embodiment, the microscope stand is made in two parts, the first part being provided for holding the observation system, and the second part is substantially positively connected to the first part. This second part includes at least one, preferably shaft-like, cavity, in which at least one electric or electronic component, which is preferably either an electric illumination system for the object to be examined by way of the observation system (in this respect the illumination system forms part of the observation system) and/or of an electronic camera system.

### FIELD OF THE INVENTION

The present invention relates to a microscope stand for holding an optical and/or opto-electronical (e.g. video) observation system, the stand being mechanically connected to a microscope base, such as a basis plate, feet or rack or the like.

### BACKGROUND OF THE INVENTION

For observing an object, the object is arranged on a microscope basis below the observation system. In order to examine the object in an efficient manner, an illumination of the object will be necessary. Depending upon the kind of the object and the intended observation procedure different illuminating devices are used as an electric light source, for example halogen cold light mirror lamps, one or more light diodes or the like. Known high power light sources are incorporated into a separate housing, and light is supplied to the object to be examined by one or more light guides. Forming the light source as a separate appliance, which can be positioned in some distance from the microscope, has the advantage that the strong heat transfer from these light sources can be kept remote from the object to be examined. However, the great disadvantage is the necessary additional space for the separate light source, because the user has to be position on his working desk two different appliances, i.e. the microscope and the separate light source, and is handicapped by the one or more light guides. The mobile use too, where two separated appliances have to be transported, is complicated and inconvenient.

It is further known to arrange light-diodes in vicinity of the object, be it close to the objective or in the basis plate of the microscope. Although one does not use high power light diodes for this purpose, but a plurality of standard light-diodes, which will be arranged either as a ring light or as a so-called spot-light near the object, such semi-conductor elements radiate heat of a relative high temperature to the object. Thus, the object is heated up, a fact, which is of great disadvantage or is even inadmissible. Moreover, arranging one or more light sources in the basis plate or microscope base increases in a disadvantageous manner its overall height.

Furthermore, it is known to arrange light sources for illuminating an object in the microscope base, on or in a focusing or support arm for the observation system or in lamp housings, which are formed on a microscope housing. All these known constructions have the disadvantage that heating-up the object cannot be prevented, in particular, because the mechanical components for holding the light-diodes, a halogen lamp or like components of the microscope, which extend up to the vicinity of the object, bring heat close to the object. It has already been suggested to use and form these components as cooling bodies for the light sources, which is advantageous for service life, e.g. of light-diodes, but is extremely disadvantageous for examining and investigating the object.

### SUMMARY OF THE INVENTION

It is, therefore, an object of the present invention, to avoid the disadvantages of the know microscope constructions and arrangements. Therefore, it is suggested, in accordance with the invention, with a microscope stand of the kind described at the outset, to form the microscope stand in two parts, the first part of which is intended for holding the observation system, whereas the second part is substantially positively connected to the first part. This second part comprises at least one, preferably shaft-like, cavity, in which at least one electric or electronic component, which is preferably either an electric illumination system for the object to be examined by means of the observation system (in this respect the illumination system forms part of the observation system) and/or of an electronic camera system. Of course, the shape of the cavity may any desired, but a shaft-like shape particularly advantageous bearing in mind the limited space available. The invention enables arranging electric or electronic components, which develop some heat during operation, in such a manner within the microscope that they are most remote from the object to be examined so that heat transfer to the object is a minimum.

Moreover, the invention provides the possibility of having sufficient space for various electric or electronic devices, necessary for the operation of the microscope, within the microscope so that an appliance is formed, which is compact and simply to transport without having the disadvantages of the known constructions.

According to a further characteristic of the invention is that the microscope comprises such an interconnecting device so as to provide a tool-free releasable interconnection between the first part and the second part. Such interconnection device may be manually operable and may comprise a quick acting closure device, such as a snap construction, or it may comprise at least one knurled screw. This characteristic has the advantage that the second part of the microscope stand can easily be replaced or exchanged on the working place itself. Such replacement may become necessary, if for example the light source in the cavity failed or if light of a different specification, such as a different wave length, is necessary for examining the object.

According to a further embodiment of the invention, it may be advantageous in dependence of the microscope's design, if also the second part is held on the microscope base by means of a manually operable quick acting closure device

As another embodiment, it is suggested that at least one clamp lever, preferably under the action of a spring, or a spring loaded latch is provided as a quick acting closure device. By such a quick acting closure device, the first and the second part of the microscope stand are securely and, nevertheless, releasably interconnected. Even a plurality or a combination of the above-mentioned quick acting closure devices ensures a stable, releasable interconnection of the first part and the second part.

According to another characteristic of the invention, it may be provided that guide pins and/or guide profiles are provided on at least one of the first and second parts for exactly positioning the first part relative to the second part and may respectively cooperate with complementary holes or profiles on the other part. In this way, quick and precise mounting of the microscope stand is made possible.

For a further embodiment of the invention, it is suggested to provide comprising at least one hole in the wall of the second part, the hole serving as a light exit. The arrangement of one or more light exits enable the use of relative short light guides, and since, in contrast to an illumination device which is positioned separately from the microscope, each light exit has a fixed position, the respective light guide can be fixed to the microscope stand and does not interfere with the examination of the object.

If it becomes necessary to use light guides of different length, is suggested according to the invention that the, preferably flexible, light guide and the light exit of the second part form a plug-in connection for externally illuminating the object.

According to a further characteristic of the invention, it is suggested that the second part of the microscope stand is adjustable in height with respect to said first part and/or relative to the microscope base. Moreover there may be at least one arm having a connection end for connecting it to the light exit hole and a free end for guiding a light guide. This arm may be pivotal on the second part of the microscope stand. It may, in some cases, be advantageous, if the arm holds a light ring for illuminating the respective object to be observed. In the case of several arms, light may illuminate the object under different angles. In any case, the invention provides a mechanically very stable object illumination connected to the microscope stand which can be arranged, if desired, in different heights above the object or below the objective of the optical observation system and, according to the requirements can be removed from the object, without the necessity of dismantling is.

According to the invention, it may be that the light exit of the second part of the microscope stand is opposite to a light entry hole, preferably both being axially aligned, and the first part comprises a light guide whose light inlet surface for illuminating the object and which is integrated into the microscope in such a way that, for example, the object can be illuminated from the microscope base, e.g. through a window in the microscope base.

As a further embodiment of the invention, it is suggested that an arm is, preferably pivotally, connected to the second part of the microscope stand and supports one or more light sources or a ring light may be releasably mounted to the second part of the microscope stand, the arm being adjustable in height above the object. In this way, the electric illumination can be brought in different positions necessary for the intended examination.

According to a further characteristic according to the invention, at least one electrical connection device for supplying at least one light source outside the wall of the cavity and remote from the microscope stand in the region of the object to be examined is provided and is situated in an opening of the wall. In this way, it is achieved that the voltage and current processing stages of the circuitry for the light source(s), which develop also some heat, are as far away from the object as possible, but exist, nevertheless, within the microscope. This arrangement too contributes clearly to heat reduction in the region of the object to be observed. Through this electrical connection, one may connect light-diodes or other light sources of any kind, such as with different colored light emission, different light intensity or the like with electric or electronic current supply and control stages accommodated in the cavity of the second part of the microscope stand.

According to the invention, mechanical holders may be provided within the cavity for holding at least one electric and/or electronic component or stages of the electric circuit for the illumination system and/or a video camera system. Since different requirements for the illumination exist for many microscopic examinations and investigations, such as different and/or adjustable light power, colored light of a different wave length or the like. Since such differently specified components be formed by the producer as individual modules, which makes the components not only cost efficient, but simplifies also combination of such components for achieving the desired light emission. In order to be able to arrange such modules in an advantageously simple way within the second part of the microscope stand, the mechanical and electric connectors/holders for the modules are provided within the cavity.

The above-mentioned modules can be interconnected in a particularly simple manner, if in accordance with a preferred embodiment of the invention, if the electric circuit comprises a contacting wire system for supplying components of said electric circuit means for module-like insertable, electric and/or electronic components or stages of the light source system and/or an electronic camera system or, in short, the observation system.

An extremely efficient heat dissipation from the microscope stand is achieved according to another embodiment of the invention, if the wall, which surrounds at least partially the cavity, comprises at least one cooling fin at the outside, averted from the first part.

In order to prevent heating up of components of the microscope, such as the microscope base, the object holder or the like, a further characteristic of the invention provides that the cavity has an insulating arrangement at least over parts of said wall means, preferably at least that part which is adjacent the first part.

In order to aid efficiently in dissipating heat from the electric components, particularly the light source, the cavity surrounding wall comprises at least one opening for the access of cooling air. If the cavity within the second part of the microscope stand is preferably shaft-like shaped, a chimney effect will advantageously be created by such opening(s), particularly if cooling air enters the cavity from an opening in the bottom and leaves it in heated up condition through an opening at top.

In the field of microscopy, it is often necessary to memorize the image of the object taken by the observation system for documentation purposes. This can be done by an electronic camera or a still picture camera or by a camera, which is positioned at the optical outlet of the observation system. In a particularly advantageous manner, such a camera system can be arranged in a microscope, if in accordance with the present invention the second part of the microscope stand second includes at least part of an electronic camera system, particularly the image processing circuitry and/or a memory. Furthermore, it is favorable, if the cavity forming wall comprises a slot or the like for introducing a mobile image memory. Moreover, the second part may have a tiltable or pivoting control image screen. Thus, all electronic or electric components, which generate heat, may be accommodated within the microscope stand, and heating the object is avoided.

In order to be able to locate a high power light source, which develops much heat, near the object and to ensure quick heat dissipation from this region, the electric circuit devices, which are situated within the cavity, and include a cooling generator for a cooling medium. In this context, “generating a cooling medium” has to be understood in the broadest sense of this expression, i.e. this device generates either a stream of cooling air or moves a cooling liquid through appropriate conduits, operates an evaporating fluid, such as Freon, so as to generate cooled air in the cavity or the like. Thus, the cooling generator may comprise at least one fan. As has already been mentioned, the cooling generator may comprise at least one conduit, such as at least one flexible hose, and this conduit may be used for directing cooling medium to a light source outside said wall means, e.g. a high power light diode. Another possibility is the use of a Peltier element as a cooling generator.

The cavity in the second part of the microscope stand offers the possibility of arranging various components and stages of a light source, of a cooling system or of an opto-electronic camera system. All these devices need electric energy. To this end, a cable has to be connected either to the mains supply or to a battery of an accumulator or the like. Therefore, it is preferred, if the electric circuit arrangement comprises at least one cable roller, because in this way it is avoided that the necessary length of the cable lies on the working table of the user. Moreover, the cable, during transport of the microscope is coiled up and stored in a minimum space within the cavity.

A further possibility within the scope of the present invention is to arrange a holder on the microscope stand, on one or the other part, preferably on the first one, such as a pivoting holder arm or the like for supporting a still picture camera or a video-camera to be oriented onto the object. This camera is advantageously releasably connected to the holder, as also the holder may be releasably connected to the microscope stand. In any case, such embodiment allows attaching of a camera for documentation purposes in a simple and stable way.

### BRIEF DESCRIPTION OF THE DRAWINGS

Further details will become apparent from the following description of embodiments schematically shown in the drawings, in which

FIGS. 1 and 2 illustrate a first embodiment of a microscope stand for a microscope in a perspective view and a lateral view respectively, the latter showing the interior of the cavity in the second part of the microscope stand;

FIGS. 3 and 4 represent a second embodiment of a microscope stand for a microscope in a perspective view and a rear view respectively;

FIGS. 5 and 6 show a third embodiment of a microscope stand for a microscope in a lateral view and a perspective view respectively;

FIG. 7 depicts a fourth embodiment of a microscope stand for a microscope in a similar view as FIG. 2;

FIG. 8 in a similar view as FIGS. 2 and 7, shows a fifth embodiment; and

FIG. 9 illustrates the arrangement of various modular electronic components and stages within a cavity of a microscope stand.

### DETAILED DESCRIPTION OF THE DRAWINGS

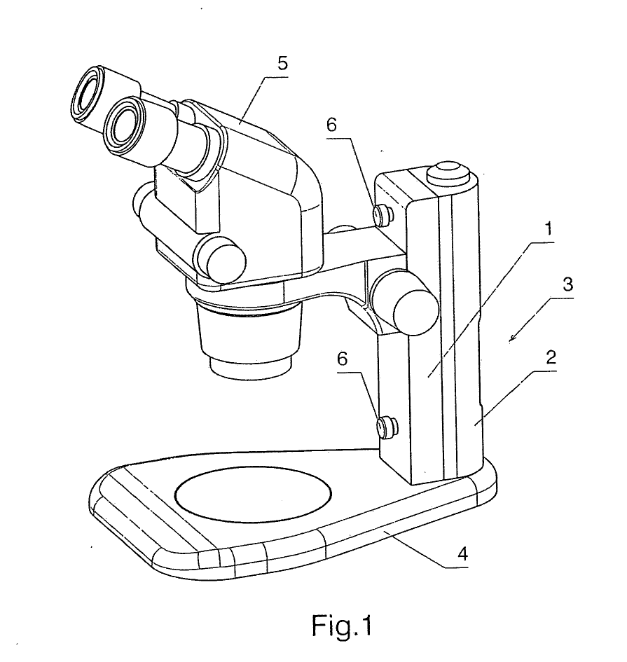

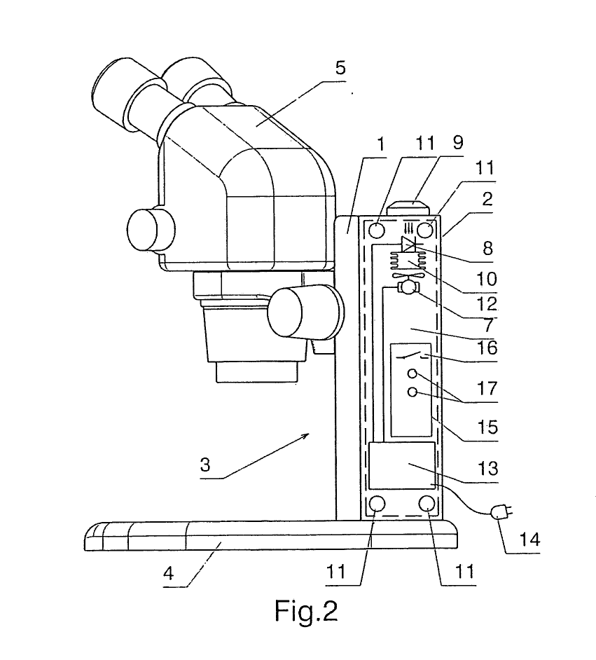

In FIGS. 1 and 2, a microscope is represented as an optical stereo-microscope. A pillar-shaped microscope stand 3 is fastened to a microscope base 4 formed as a base plate. An optical observation system 5 is adjustably connected to the microscope stand 3 in a certain, and in general adjustable, height above the microscope base 4.

The microscope stand 3 is formed in parts and consists of a first part 1 and a second part 2. The first part 1 is intended to hold the optical observation system 4 and its bottom portion is firmly connected to the microscope base 5. The second part 2 of the microscope stand 3 is releasably connected to the first part 1 by a quick acting closure device. This quick acting closure device, in the case of FIGS. 1 and 2, is formed by at least one screw 6, which is provided with a milled knob so as to form a thumb or knurled screw to avoid that a user has to employ a tool for releasing it. The quick acting closure device, however, can be of any kind, for example it can be formed by a spring loaded clamping lever, which may engage a clamp rail. Alternatively, it may be a spring loaded and releasable latch or locating device, catch or the like.

In addition, the second part 2 of the microscope stand 3 may also mechanically be connected in a tool-free releasable way to the microscope base 4. The second part 2 of the microscope stand 3 is hollow so that its walls surround a cavity 7. This cavity 7, as shown in interrupted̂lines in FIG. 2, extends substantially over the whole height of the microscope stand 3.

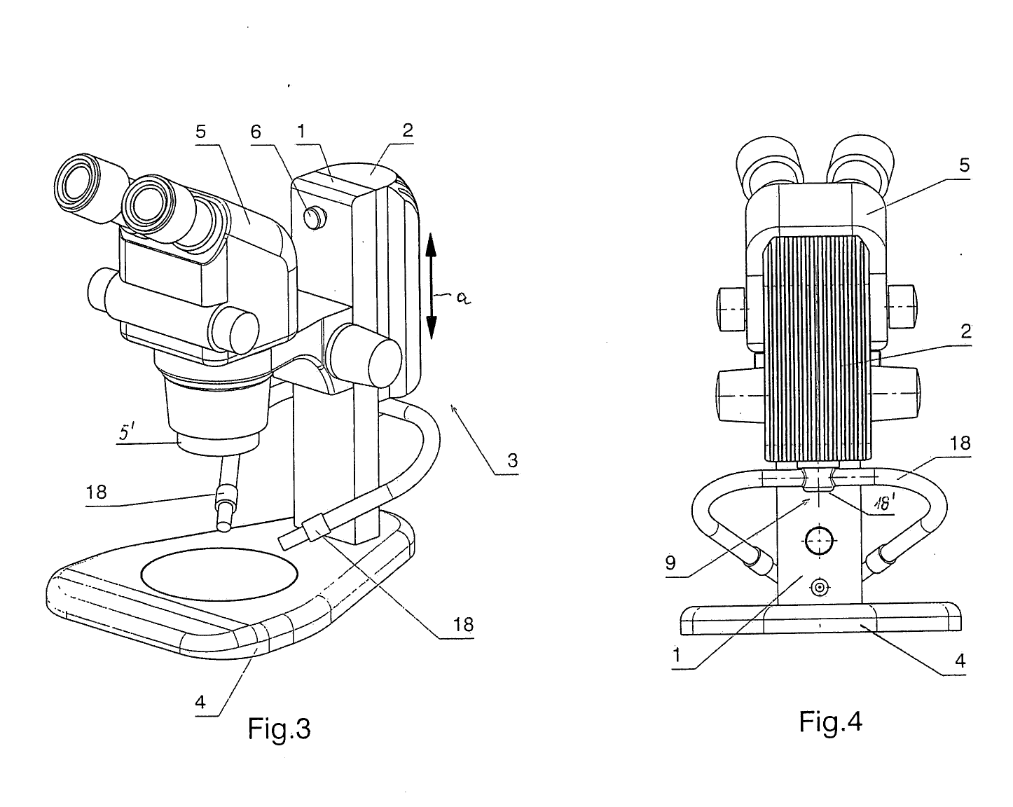

The cavity 7 in the second part 2 of the microscope stand is, thus, shaft-like (FIG. 2) and forms a housing, which is positively connected to the first part 1. In this shaft-like cavity 7 is an electric light source, preferably in the form of a high power light diode 8 which is opposite a tip jack 9 for fastening a light guide (not shown in FIGS. 1 and 2, but, for example in FIGS. 3 and 4) for illuminating an object on the microscope base 4, thus forming a light exit. This light source 8 is provided with a cooling body 10, which dissipates heat generated by the light source and will, thus create a certain air circulation. In the walls of the second part 2 of the microscope stand 3, openings 11 are formed for the inlet of fresh air from outside and for discharging heated air to the exterior of the cavity 7 so that a cooling air stream is generated which is promoted by the shaft-like shape of the second part 2 that confers a chimney effect to it, since the openings 11 are in the lower and upper regions of the cavity. Air circulation may actively be promoted by a fan 12 driven by an electric motor, as an additional cooler.

A current and voltage former stage 13 is situated within the cavity 7 for supplying electrical energy to the light source 8. The current and voltage former stage 13 is connected to the mains supply by a conductor or cable 14. Alternatively, energy supply to electric and/or electronic components within the cavity 7 is effected by an external current source, by an external low voltage appliance or the like. In a likewise manner an accumulator or a battery (not shown) may be incorporated into the cavity 7 of the second part 2, which renders it possible to use the microscope, if desired, in a mobile manner, even in natural surroundings without any electric-supply line or mains supply. In a control panel 15 of the second part 2 of the microscope stand 3, a switch 16 for activating the light source 8 and some control signal lamps 17.

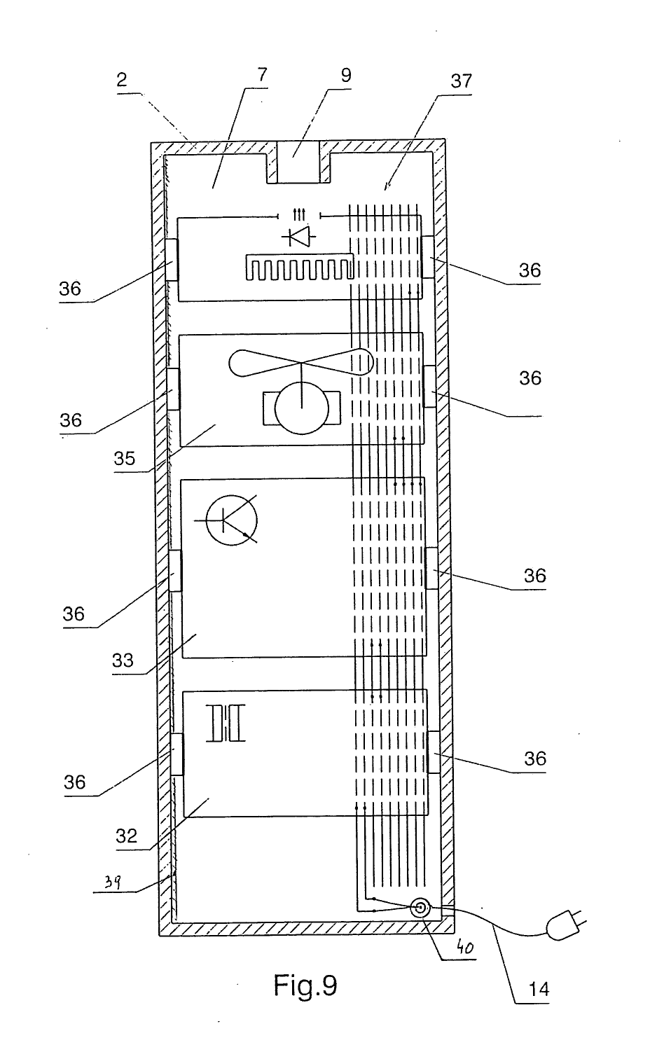

Within the cavity 7 a cable roller may be provided for the cable 14, such a cable roller being schematically indicated in FIG. 9, although is not shown in FIG. 2. this cable roller may be operated either by a mover, such as a spring, a motor, or even manually.

Furthermore, electronic components of a wireless or wired remote control appliance for the light source 8 may be arranged within the cavity 7. Such appliance may be used for switching the light source 8 in and out, but it may also be used for changing light intensity or, with some types of light diodes and other light source, for changing the color temperature or color of light.

In the second embodiment according to FIGS. 3 and 4 and for all embodiments, reference numerals for equivalent parts are the same as in FIGS. 1 and 2. The microscope stand 3 is formed in such a manner, that the second part 2, releasably and positively attached to the first part 1, has a shortened overall height in comparison with that of the first part 1. In the cavity of the second part 2, which is not shown, but can be in an analogous way as in FIG. 2 or 9, suitably the light source together with some or all of the electric and electronic components are arranged which have been described with reference to FIG. 2. In contrast to the embodiment of FIGS. 1 and 2, the light exit 9 and a double plug-in connecting piece 18′, are arranged on that surface of the second part 2 of the microscope stand, which faces the microscope base 4. A respective light guide 18 is plugged into either side of the plug-in connecting piece or tip jack 18′, and these light guides 18 guide light of the light source accommodated in the cavity (7) in FIG. 2) of the second part 2 of the microscope stand 3 around the first part 1 of the microscope stand 3, which supports the optical observation system 5 so as to illuminate an object, which lies on the microscope base 4 below the objective 5′ of the optical observation system 5.

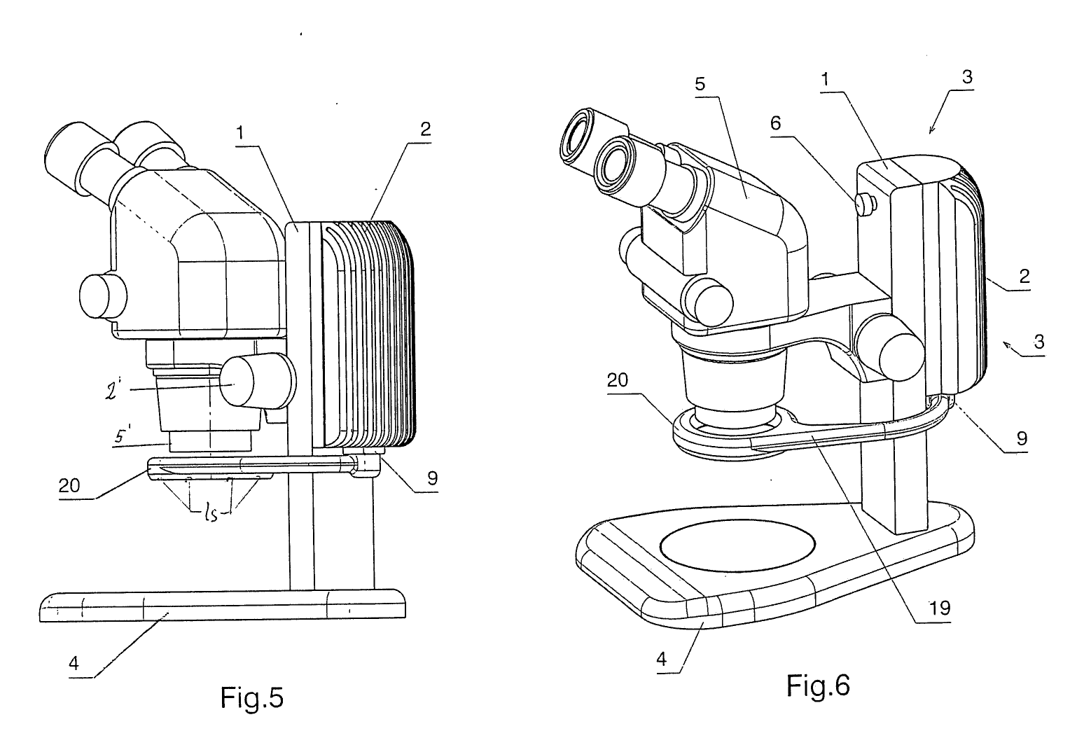

In the third embodiment according to FIGS. 5 and 6, the mechanical details in the region of the light exit 9 in the second part 2 of the microscope stand 3, with respect to FIGS. 3 and 4, are modified. A substantially horizontally pivoted arm 19 is supported at the light exit 9, suitably also formed as a plug-in connection or tip jack. The arm 19 is hollow and has a light guide incorporated, the light guide extending from the light exit 9 to a ring light 20 on the other end of the arm 19, which serves for illuminating the object from above. As an alternative, the tip jack 9 is formed as an electric connector and the hollow arm has at least one wire incorporated which leads to light sources is (which in the first case represent the exit surfaces of the light guide). Since, in this embodiment, the second part 2 of the microscope stand 3 is shorter in vertical direction than the first part 1, it can be positioned at different heights on the first part 1 (cf. arrow a in FIG. 3). Fastening the second part 2 at different heights above the microscope base 4 can be realized in different ways known to those skilled in the art. For example, a knob similar to knob 2′ may be connected to a pinion (not shown) which engages a toothed rack connected to the second part 2, which in turn is linearly guide on the first part. As an alternative, part 2 may have a plurality of tapped holes at different heights and spaced from one another in vertical direction so that screws 6 (cf. FIGS. 1 and 2) may be screwed in one tapped hole or the other.

As an alternative, at least two arms 9 may be provided and may be pivoted in position around the objective 5′, e.g. so that one arm carries a ring light with diodes in it, and possibly being of a different color in comparison to a second arm, which houses a light guide for guiding white light from a light-diode in the cavity of the second part 2. Another possibility is that the light exits on the ring lights of the two arms have a different inclination angle towards the object so that light may illuminate the object in an optimized way, even when the second part 2 is position on the first part in different heights.

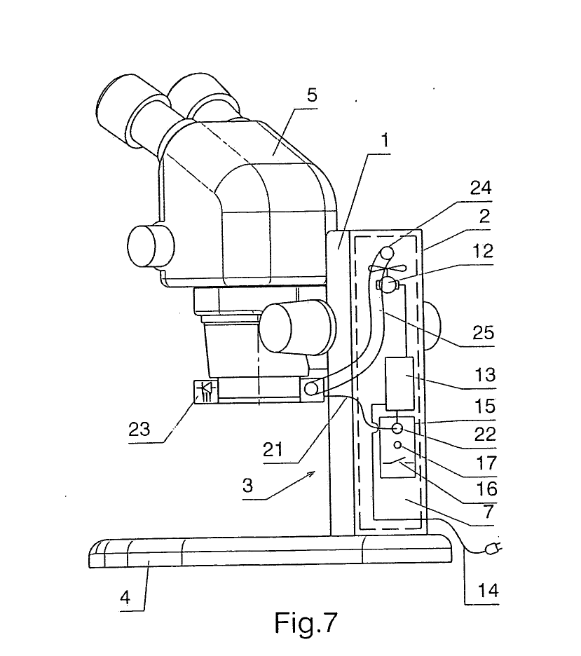

In the embodiment according to FIG. 7, the electronic voltage former stage 13 is arranged in the cavity 7 of the second part 2. In the control panel 15 is a switch 16 is provided (cf. FIG. 2), as well as a control lamp 17 indicating the position of the switch 16 or the operational condition of the stage 13. Additionally a tip jack 22 is provided on the control panel 15 for supplying energy to one or more electric light sources (not shown), which are separated from the microscope stand 3 and the observation system 5, thus from the microscope as a whole. Such light sources may be formed as a so-called LED-light spot. Alternatively, as shown, the tip jack 22 may be used to activate a ring light 23 having light diodes (cf. is in FIG. 5) which have to be supplied with electric energy.

In addition, the electro-motor driven fan 12 may be provided which generates a cooling air stream exiting through an air exit hole 24 in the wall of the second part 2. An air hose 25 guides the cooling air stream to the housing of the LED-ring light 23. It is clear that, here again, a liquid cooling medium may be used for cooling the light diodes of the ring light 23. To this end, a cooling generator, such as a heat exchanger and a pump for the liquid cooling medium may be incorporated into the cavity 7.

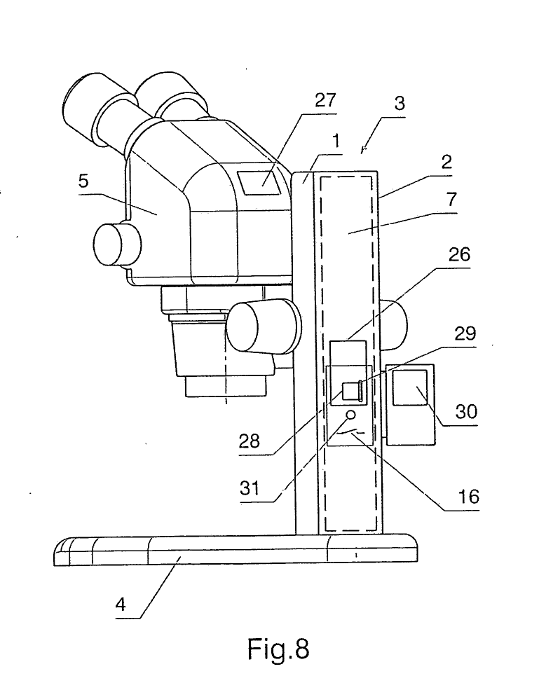

The embodiment of FIG. 8 shows a microscope with a two-part microscope stand 3, in the cavity 7 of which is an electronic image processing system 26, which is connected by a signal line (not shown) to an image sensor 27 incorporated into the optical observation system 5. The image processing system 26 is furthermore in contact with an image memory 28 which may be a RAM in the cavity, but preferably is an external memory so that the walls of the second part 2 may have another tip jack connected to the image processing system 26 over which data or signals are transferred to the external memory. A mobile image memory 28 may be formed by a digital memory card which can be inserted into the cavity 7 through a slot-shaped opening 29 in the second part 2 of the microscope stand 3 to contact the image processing system 26. In the control panel 15 is the in-and-out switch 16 for the image processing system 26 and a key 29 for activating the data transfer from the image processing system 26 to the image memory 28. A control image screen 30 for the image processing system 26 is suitably pivoted on the microscope stand 3, preferably on the first part 1 of it. This control image screen 30 may be pivoted in such a way that it covers, in inoperative position, the control panel 15.

In the embodiments described with reference to FIGS. 1 to 8, in addition to the quick acting closure device for releasably interconnecting the first and second parts 1 or 2, one part may have guiding means, as has already been mentioned, e.g. in the form of guide bores, guide grooves or guide rails, while the other part has a complementary guiding element so as to be well positioned with respect to each other.

In FIG. 9, the second part 2 of the microscope stand 3 is in cross-section so as to see the individual electric or electronic components incorporated into the cavity 7. In the cavity 7, there is a plurality of electric conductors 31, which are only schematically indicated. These conductors 31 form a wiring and contacting system for the electric or electronic devices necessary for operating the microscope. A pair each of conductors 31 is assigned to one of the components, including a modular light source 37 provided with at least one light diode.

Energy is supplied through the cable 14 on a cable roller 40 to a voltage transforming module 32. The output of the voltage transforming module 32 is in the form of another pair of conductors 31 to supply low voltage to a control module 33 for controlling light intensity of the light source module 37 and/or a fan module 35, to which the voltage transforming module is connected via another pair of conductors 31 each.

The conductors 31 extend almost over the whole height of the microscope stand 3 so that the cavity is prepared to receive the plurality of modules 32 to 37 of different function and, possibly, of different overall size or shape. In order to easily contact these modules, manually releasable contact pins may be provided, while for mechanically holding the modules 32 to 37, clamps 36 may be foreseen. Alternatively, the modules may be screwed in the respective place. Another alternative is that the clamps 36 constitute also electrical contacts so that with the insertion of the respective module 32 to 37, it is firmly held and simultaneously contacted by the clamps 36.

The invention is not limited to the embodiments as described so far. For example, it is within the scope of the invention to arrange a light exit in the second part 2 for the internal light source in cavity 7 in such a way that the light exit is directed towards the first part 1 of the microscope stand 3 or towards the microscope base 4, where a light inlet window may be provided. A light guide close to this window may then guide the light towards the object, in the case of a window in the microscope base 4 to illuminate the object from below.

As may be seen in FIG. 9, at least part of the walls, preferably at least that part of the walls, which surround the cavity 7 may be lined with a heat protection or insulating layer 39 or may be provided with some other shielding (e.g. a reflecting layer) in order to isolate the second part 2 thermally from the other components of the microscope, and in particular form the first part 1 of the microscope stand 3.

What is claimed is:

1. A microscope stand, comprising:
a base, to be set onto a supporting surface;
a stay device, connected to said base, to stay upright on said base and thereby define an upright direction, said stay device including at least
a first part extending in the upright direction and being secured to said base, and
a second part, formed as a wall element and extending in the upright direction, the wall element surrounding a cavity and being positively and releasably connectable to said first part; and
an observation system on said stay device, to look at an object to be observed, said observation system being supported by said first part of said stay device and including an electric circuit device, situated within said cavity of said second part of said stay device.

2. Microscope stand as claimed in claim 1, further comprising:
an interconnecting device to provide a tool-free releasable interconnection between said first part and said second part of said stay device.

3. Microscope stand as claimed in claim 2, wherein said interconnection device comprises a manually actuable quick acting closure device, provided on said first part of said stay device.

4. Microscope stand as claimed in claim 3, wherein said quick acting closure device comprises at least one knurled screw.

5. Microscope stand as claimed in claim 1, wherein said wall element comprises at least one cooling fin at the outside, averted from said first part of said stay device.

6. A microscope stand, comprising:
a base, to be set onto a supporting surface;
a stay device, connected to said base, to stay upright on said base and thereby define an upright direction, said stay device including at least
a first part extending in the upright direction and being secured to said base, and
a second part, formed as a wall element and extending in the upright direction, the wall element surrounding a cavity and being releasably connectable to said first part, said second part being relatively shorter in height than said first part and being adjustable in height with respect to said first part; and
an observation system on said stay device, to look at an object to be observed, said observation system being supported by said first part of said stay device and including an electric circuit device situated within said cavity of said second part of said stay device, said electric circuit device including a control panel, accessible from outside said wall element of said second part of said stay device.

7. A microscope stand, comprising:
a base, to be set onto a supporting surface;
a stay device, connected to said base to stay upright on said base and thereby define an upright direction, said stay device including at least
a first part, extending in the upright direction and being secured to said base, and
a second part, formed as a wall element and extending in the upright direction, the wall element surrounding a cavity and being releasably connectable to said first part; and
an observation system on said stay device, to look at an object to be observed, said observation system being supported by said first part of said stay device and including an electric circuit device situated within said cavity of said second part of said stay device and including an electric light source.

8. Microscope stand as claimed in claim 7, further comprising at least one hole in said wall element of said second part of said stay device, which serves as a light exit.

9. Microscope stand as claimed in claim 7, further comprising a light guide connected to said at least one hole.

10. Microscope stand as claimed in claim 9, wherein said light guide and said at least one hole form a plug-in connection.

11. A microscope stand, comprising:
a base, to be set onto a supporting surface;
a stay device, connected to said base to stay upright on said base and thereby define an upright direction, said stay device including at least
a first part, extending in an upright direction and being secured to said base, and
a second part, formed as a wall element and extending in the upright direction, the wall element surrounding a cavity and being releasably connectable to said first part; and
an observation system on said stay device, to look at an object to be observed, said observation system being supported by said first part of said stay device and including an electric circuit device situated within said cavity of said second part of said stay device and including an energy transfer device,
wherein the wall element of said second part of said stay device comprises
at least one hole in said wall element of said second part of said stay device, which serves as a light exit,
a light guide, connected to said hole, and
at least one arm having a connection end for connecting to said hole and a free end for guiding said energy transfer device.

12. Microscope stand as claimed in claim 11, wherein the free end of said at least one arm holds a light ring for illuminating the respective object to be observed.

13. Microscope stand as claimed in claim 11, wherein said arm is pivotal.

14. Microscope stand as claimed in claim 11, wherein said energy transfer device comprises a light guide.

15. Microscope stand as claimed in claim 11, wherein said energy transfer device comprises at least one electric conductor.

16. A microscope stand, comprising:
a base, to be set onto a supporting surface;
a stay device, connected to said base to stay upright on said base and thereby define an upright direction, said stay device including at least
a first part, extending in the upright direction and being secured to said base, and
a second part, formed as a wall element and extending in the upright direction, the wall element surrounding a cavity and being releasably connectable to said first part; and
an observation system on said stay device, to look at an object to be observed, said observation system being supported by said first part of said stay device and including an electric circuit device, situated within said cavity of said second part of said stay device and including an electrical connection for supplying at least one light source outside said wall element.

17. A microscope stand, comprising:
a base, to be set onto a supporting surface;
a stay device, connected to said base to stay upright on said base and thereby define an upright direction, said stay device including at least
a first part, extending in the upright direction and being secured to said base, and
a second part, formed as a wall element and extending in the upright direction, the wall element surrounding a cavity and being releasably connectable to said first part; and
an observation system on said stay device, to look at an object to be observed, said observation system being supported by said first part of said stay device and including an electric circuit device, situated within said cavity of said second part of said stay device and including a cooling device for generating a cooling medium.

18. Microscope stand as claimed in claim 17, wherein said cooling device comprises at least one fan.

19. Microscope stand as claimed in claim 17, further comprising a conduit device for directing said cooling medium to a light source outside said wall element.

20. Microscope stand as claimed in claim 17, wherein said wall element comprises at least one opening for the access of cooling air.

21. A microscope stand, comprising:
a base, to be set onto a supporting surface;
a stay device, connected to said base to stay upright on said base and thereby define an upright direction, said stay device including at least
a first part, extending in the upright direction and being secured to said base, and
a second part, formed as a wall element and extending in the upright direction, the wall element surrounding a cavity and being releasably connectable to said first part; and
an observation system on said stay device, to look at an object to be observed, said observation system being supported by said first part of said stay device and including an electric circuit device situated within said cavity of said second part of said stay device, wherein said second part of said stay device comprises a mechanical holding device, within said cavity, for holding at least one component of said electric circuit device.

22. Microscope stand as claimed in claim 21, wherein said electric circuit device comprises a mains supply device and circuitry and contacting wire system for supplying components of said electric circuit device.

23. Microscope stand as claimed in claim 22, wherein said electric circuit device comprises a cable roller.

24. A microscope stand, comprising:
a base, to be set onto a supporting surface;
a stay device, connected to said base to stay upright on said base and thereby define an upright direction, said stay device including at least,
a first part, extending in the upright direction and being secured to said base, and
a second part, formed as a wall element and extending in the upright direction, the wall element surrounding a cavity and being releasably connectable to said first part; and
an observation system on said stay device, to look at an object to be observed, said observation system being supported by said first part of said stay device and including an electric circuit device, situated within said cavity of said second part of said stay device and including at least part of an electronic camera system.

25. Microscope stand as claimed in claim 24, wherein the part of the electronic camera system, which is situated in said cavity, comprises an image processing system.

26. Microscope stand as claimed in claim 24, wherein the part of the electronic camera system, which is situated in said cavity, comprises a memory.

27. Microscope stand as claimed in claim 24, wherein said wall element comprises a slot for introducing a mobile image memory.

28. Microscope stand as claimed in claim 24, wherein said wall device comprises an outside control image screen connected to said electric circuit device.

29. Microscope stand as claimed in claim 28, wherein said control image screen is pivotally mounted to said wall element.

30. A microscope stand, comprising:
a base, to be set onto a supporting surface;
a stay device, connected to said base to stay upright on said base and thereby define an upright direction, said stay device including at least
a first part, extending in the upright direction over a length, and being secured to said base, and
a second part formed as wall element and extending in the upright direction substantially over the entire length of said first part, the wall element surrounding a cavity and being positively and releasably connectable to said first part; and
an observation system on said stay device, to look at an object to be observed, said observation system being supported by said first part of said stay device and including an electric circuit device, situated within said cavity of said second part of said stay device.

31. A microscope stand, comprising:
a base, to be set onto a supporting surface;
a stay device, connected to said base to stay upright on said base and thereby define an upright direction, said stay device including at least
a first part, extending in the upright direction and being secured to said base, and
a second part, formed as a wall element and extending in the upright direction, the wall element surrounding a cavity and being positively and releasably connectable to said first part, the cavity including insulation at least over parts of said wall element; and
an observation system on said stay device, to look at an object to be observed, said observation system being supported by said first part of said stay device and including an electric circuit device situated within said cavity of said second part of said stay device.
